(19) United States
(12) Patent Application Publication
(10) Pub. No.: US 2017/0180807 A1
(43) Pub. Date: Jun. 22, 2017

(54) METHOD AND ELECTRONIC DEVICE FOR AMPLIFYING VIDEO IMAGE

(71) Applicants: LE HOLDINGS (BEIJING) CO., LTD., Beijing (CN); LE SHI INTERNET INFORMATION & TECHNOLOGY CORP., BEIJING, BEIJING (CN)

(72) Inventor: Zheng HE, Beijing (CN)

(21) Appl. No.: 15/245,086

(22) Filed: Aug. 23, 2016

Related U.S. Application Data
(63) Continuation of application No. PCT/CN2016/089173, filed on Jul. 7, 2016.

(30) Foreign Application Priority Data
Dec. 18, 2015 (CN) 201510956776.5

(51) Int. Cl. H04N 21/4728; H04N 21/422; H04N 21/44; H04N 21/431

(52) U.S. Cl. CPC H04N 21/4728; H04N 21/4316; H04N 21/42224; H04N 21/44008

(57) ABSTRACT

The present disclosure is related to methods and electronic devices for amplifying a video image. Illustrative methods herein may include detecting a pressure value corresponded to a press operation when the press operation is received in a target display region of a display screen, generating a video window at a preset location of the display screen when the pressure value corresponded to the press operation is greater than a threshold, and amplifying the video image in the target display region to a preset multiples and displaying it in the video window. According to aspects of the present disclosure, a video window may be generated at a preset location of the display screen, so that a video image in the target display region may be conveniently amplified to preset multiples and displayed in the video window.

### CROSS REFERENCE TO RELATED APPLICATIONS

This application is a continuation of International patent application No. PCT/CN2016/089173, with an international filing date of Jul. 7, 2016 (attached hereto as an Appendix), which claims priority to Chinese Patent Application CN201510956776.5, filed with State Intellectual Property Office on Dec. 18, 2015, and entitled “METHOD AND DEVICE FOR AMPLIFYING VIDEO IMAGE”, all of which are incorporated herein by reference in entirety.

### BACKGROUND

Technical Field

The present disclosure relates to the field of communication technologies, and in particular, to a method and an electronic device for amplifying a video image.

Description of Related Information

With the progress of technologies, the number of users that watch a video via mobile terminals becomes larger and larger. When a user watches a video via a display screen of a mobile terminal, it often occurs that some details of the video cannot be seen clearly due to a small display screen of the mobile terminal.

For example, in case a user plays via a mobile terminal a video which is a vocal concert of star A, he cannot clearly see the star A standing on the stage, because what is displayed in the video is a picture of the whole stage while the display screen of the mobile terminal is small.

Because the display screen of the mobile terminal is relatively small, it often occurs that the user cannot clearly seen certain details of the video on the display screen of the mobile terminal, thus the video watching experience of the user will be deteriorated.

### OVERVIEW OF SOME ASPECTS

The present disclosure relates to methods and electronic devices for amplifying a video image, thereby a video image in a target display region on a display screen may be amplified, and hence a video watching requirement of a user may be met.

According to a first aspect of the embodiments of the disclosure, there provides a method for amplifying a video image, which includes:

detecting a pressure value corresponded to a press operation when the press operation is received in a target display region of a display screen;

generating a video window on a preset location of the display screen when the pressure value corresponded to the press operation is greater than a threshold; and

amplifying the video image in the target display region to a preset multiples and displaying it in the video window.

The present disclosure further provides a non-transitory computer-readable storage medium storing executable instructions that, when executed by an electronic device with a touch-sensitive display, cause the electronic device to execute any one of the methods for amplifying a video image described above.

The present disclosure further provides an electronic device including at least one processor and a memory communicably connected with the at least one processor for storing instructions executable by the at least one processor, wherein execution of the instructions by the at least one processor causes the at least one processor to execute any one of the methods for amplifying a video image described above.

### BRIEF DESCRIPTION OF THE DRAWINGS

One or more embodiments are illustrated by way of example, and not by limitation, in the figures of the accompanying drawings, wherein elements having the same reference numeral designations represent like elements throughout. The drawings are not to scale, unless otherwise disclosed.

FIG. 1 is a flow chart of a method for amplifying a video image according to one embodiment of the disclosure;

FIG. 2 is a flow chart of another method for amplifying a video image according to one embodiment of the disclosure;

FIG. 3 is a flow chart of yet another method for amplifying a video image according to one embodiment of the disclosure;

FIG. 4 is a flow chart of yet another method for amplifying a video image according to one embodiment of the disclosure;

FIG. 5 is a flow chart of yet another method for amplifying a video image according to one embodiment of the disclosure; and

FIG. 6 is a diagram illustrating a hardware structure of the method for amplifying a video image provided by an embodiment of the disclosure.

### DETAILED DESCRIPTION OF ILLUSTRATIVE IMPLEMENTATIONS

The technical solutions in the embodiments of the disclosure will be described clearly and fully below in conjunction with the drawings in the embodiments of the disclosure. It should be apparent that the embodiments described herein are only a part of the embodiments of the full invention/disclosure, rather than all of the embodiments. All the other embodiments obtained by one of ordinary skills in the art based on the embodiments of the disclosure without creative work pertain to the protection scope of the disclosure.

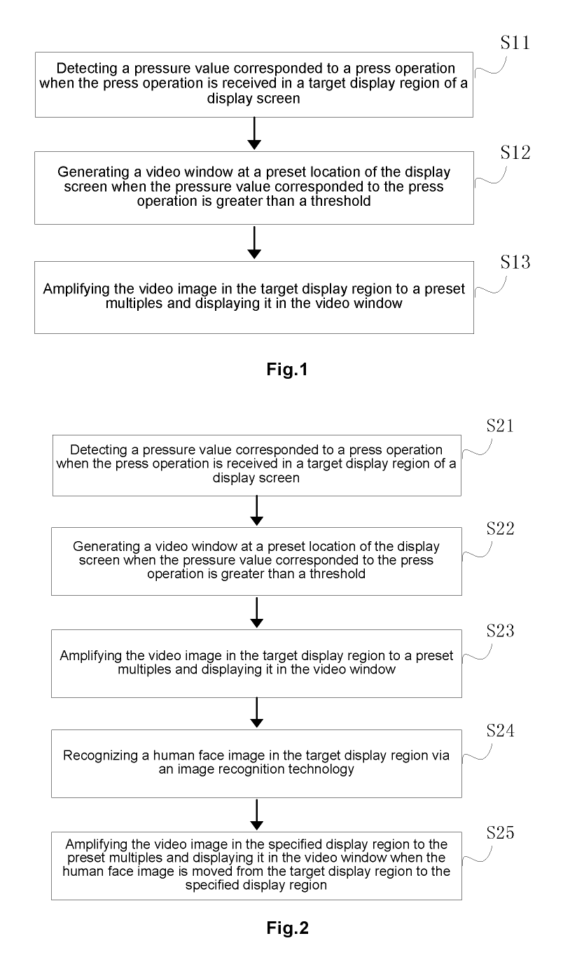

FIG. 1 is a flow chart of a method for amplifying a video image according to one embodiment of the disclosure. The method for amplifying a video image shown in FIG. 1 may be applied to a mobile terminal. According to the method for amplifying a video image according to the disclosure, an amplified video image in a target display region may be displayed in a video window, so that a user may clearly see in the video window the video image in the target display region, thereby the video watching requirement of the user can be met. The method includes the steps of:

In Step S11: detecting a pressure value corresponded to a press operation when the press operation is received in a target display region of a display screen.

Wherein, the method according to the disclosure may be applied to a mobile terminal with a display screen, and the mobile terminal may be an apparatus such as an intelligent mobile phone or a tablet computer, etc.

The target display region of a display screen refers to a region that is pressed by a user via a finger or a touch pen. For example, if the user presses a central region of the display screen via a finger, the central region of the display screen will be the target display region. In another example, if the user presses a top right region of the display screen via a touch pen, the top right region of the display screen will be the target display region.

A sensor for sensing pressure may be provided on the display screen of the mobile terminal. When a video image is displayed on the display screen, the user may press any display region of the display screen via a finger or a touch pen. When the target display region of the display screen receives a press operation input by the user, the sensor of the display screen will detect the pressure value of the press operation.

For example, assuming that the mobile terminal is an intelligent mobile phone equipped with a touch screen with a pressure sensor provided thereon, and a video image is currently displayed on the intelligent mobile phone. When the user presses a target display region on the touch screen, the touch screen of the intelligent mobile phone will detect the pressure value applied by the user via a finger. Assuming that the user presses the target display region of the touch screen via a force of 2 N by the finger, the touch screen of the intelligent mobile phone will detect that the pressure value of the press operation is 2 N.

In Step S12: generating a video window at a preset location of the display screen when the pressure value corresponded to the press operation is greater than a threshold.

Wherein, the threshold refers to a preset pressure value, for example, the threshold may be set as 3 N in advance. The threshold may be set by a user according to his/her own habits. Of course, the threshold may also be set uniformly on manufacture, such that a user cannot change it at will.

The preset location of the display screen is a location that is preset, for example, the preset location may be set on a top right corner of the display screen; in another example, the preset location may be set on a top left corner of the display screen.

When the mobile terminal judges that the pressure value corresponded to the press operation is greater than the threshold, which means that the user wants to watch the video image in the target display region carefully, then the mobile terminal will generate a video window at the preset location of the display screen, such that the mobile terminal may amplify the video image in the target display region to a preset multiples and display it in the video window, so that the user can watch in the video window an amplified video image of the target display region.

The frame of the video window may change according to the size of the actual video image to be displayed, thus the size of the video window is not fixed.

In Step S13: amplifying the video image in the target display region to a preset multiples and displaying it in the video window.

Wherein, the preset multiples refers to a multiplication factor that is preset. For example, the preset multiples may be set as 2 in advance.

After generating a video window at a preset location of the display screen, the mobile terminal will amplify the video image in the target display region to the preset multiples, and then display the amplified video image in the video window, so that the user can see the video image of the target display region clearly in the video window.

For example, the following parameters may be set in advance, wherein, the threshold is 1 N, the preset location of the display screen is the top right corner of the display screen, and the preset multiples is 2. Assuming that a user is watching a vocal concert of star A via a display screen of a mobile terminal. Because what is displayed on the display screen is a video image of the whole stage, the user cannot clearly see the star A at the central region of the display screen; thus, the user presses on the central region of the display screen. At this point, the central region of the display screen receives a press operation input by the user, and the mobile terminal will detect the pressure value corresponded to the press operation. The mobile terminal detects that the pressure value corresponded to the press operation is 3 N, and determines that the pressure value 3 N corresponded to the press operation is greater than the threshold 1 N; then, the mobile terminal will generate a video window at the top right corner of the display screen, amplify the video image in the central region of the display screen by a factor of two and then display it in the video window, so that the user can clearly see in the video window the video image of the central region.

In the embodiment shown in FIG. 1, when the pressure value corresponded to the press operation received in the target display region is greater than a threshold, it means that the user wants to watch an amplified video image of the target display region. Therefore, in the solutions of the disclosure, a video window will be generated at a preset location of the display screen, so that the video image in the target display region may be amplified to a preset multiples and displayed in the video window. At this point, the user may watch in the video window the amplified video image of the target display region, so that he may clearly see in the video window the video image of the target display region, thereby the video watching requirement of the user can be met.

FIG. 2 is a flow chart of another method for amplifying a video image according to one embodiment of the disclosure. FIG. 2 is an optional embodiment based on FIG. 1, and in the embodiment shown in FIG. 2, for the part the same as that of the embodiment shown in FIG. 1, reference may be made to the introduction and explanation in the embodiment shown in FIG. 1. The method shown in FIG. 2 includes the steps of:

In Step S21: detecting a pressure value corresponded to a press operation when the press operation is received in a target display region of a display screen;

In Step S22: generating a video window at a preset location of the display screen when the pressure value corresponded to the press operation is greater than a threshold;

In Step S23: amplifying the video image in the target display region to a preset multiples and displaying it in the video window;

In Step S24: recognizing a human face image in the target display region via an image recognition technology.

Wherein, the image recognition technology may determine whether a human face image exists in the target display region by recognizing the facial features on the human face.

For example, assuming that the video image in the target display region on the display screen is a human face image of star A, after the mobile terminal amplifies the video image in the target display region to a preset multiples and displays it in the video window, the mobile terminal will continue to recognize the human face image of star A in the target display region via image recognition technology.

In Step S25: amplifying the video image in a specified display region to a preset multiples and then displaying it in the video window when the human face image is moved from the target display region to the specified display region.

Wherein, when the mobile terminal recognizes the human face image in the target display region, the mobile terminal will determine whether the human face image is moved from the target display region to other display regions. When the mobile terminal determines that the human face image has been moved from the target display region to the specified display region, it means that the human face image to which the user pays attention is no longer in the target display region, but is rather moved to the specified display region on the display screen. Therefore, in order to display the human face image to which the user pays attention in the video window all the time, the mobile terminal will amplify the video image of the specified display region to the preset multiples and display it in the video window.

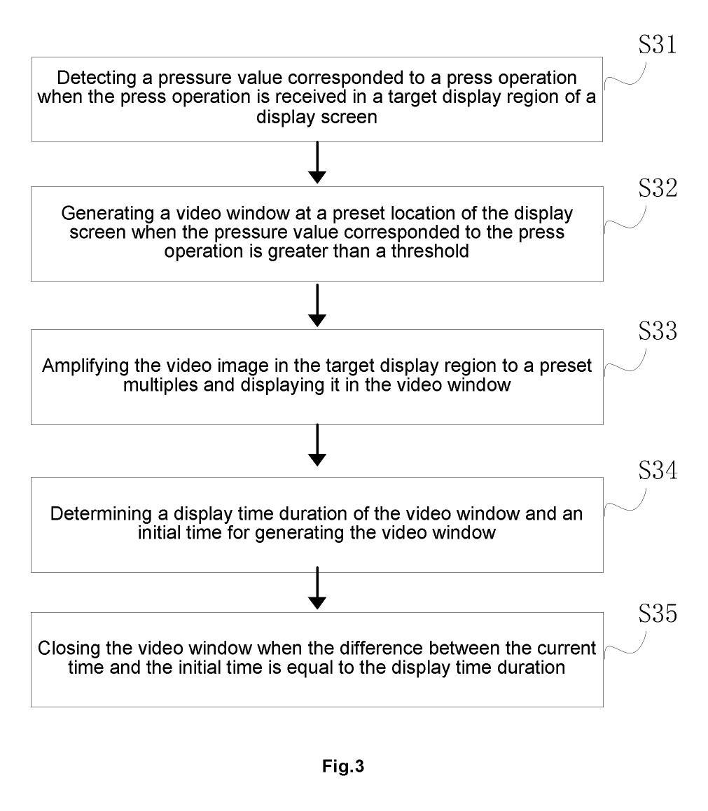

FIG. 3 is a flow chart of yet another method for amplifying a video image according to one embodiment of the disclosure. FIG. 3 is an optional embodiment based on FIG. 1, and in the embodiment shown in FIG. 3, for the part the same as that of the embodiment shown in FIG. 1, reference may be made to the introduction and explanation in the embodiment shown in FIG. 1. The method shown in FIG. 3 includes the steps of:

In Step S31: detecting a pressure value corresponded to a press operation when the press operation is received in a target display region of a display screen;

In Step S32: generating a video window at a preset location of the display screen when the pressure value corresponded to the press operation is greater than a threshold;

In Step S33: amplifying the video image in the target display region to a preset multiples and displaying it in the video window;

In Step S34: determining a display time duration of the video window and an initial time for generating the video window.

Wherein, the display time duration of the video window refers to the time duration in which the video window is present on the display screen. For example, assuming that the display time duration of the video window is set as 1 minute in advance, then the mobile terminal will start timing when the video window gets generated; when the time duration in which the video window is present on the display screen is 1 minute, the mobile terminal will close the video window.

In many cases, the user does not expect that the video window remains on the display screen for a long time. Thus, after the video window is generated, the mobile terminal needs to determine the display time duration of the video window and an initial time for generating the video window.

In Step S35: closing the video window when the difference between the current time and the initial time is equal to the display time duration.

Wherein, after determining the display time duration of the video window and an initial time for generating the video window, the mobile terminal starts to determine whether the difference between the current time and the initial time is equal to the display time duration. When the mobile terminal determines that the difference between the current time and the initial time is equal to the display time duration, the mobile terminal will close the video window.

For example, assuming that the user sets the display time duration of the video window as 1 minute in advance. After the mobile terminal amplifies the video image in the target display region to a preset multiples and displays it in the video window, the mobile terminal will determine the display time duration of the video window and an initial time for generating the video window; assuming that the mobile terminal determines that the initial time for generating the video window is 12:10, then the mobile terminal will determine whether the difference between the current time and the initial time 12:10 is equal to the display time duration. When the current time is 12:11, the mobile terminal will determine that the 1 minute difference between 12:11 and the initial time 12: 10 is equal to the 1 minute display time duration, thus close the video window so as to meet the user's requirement.

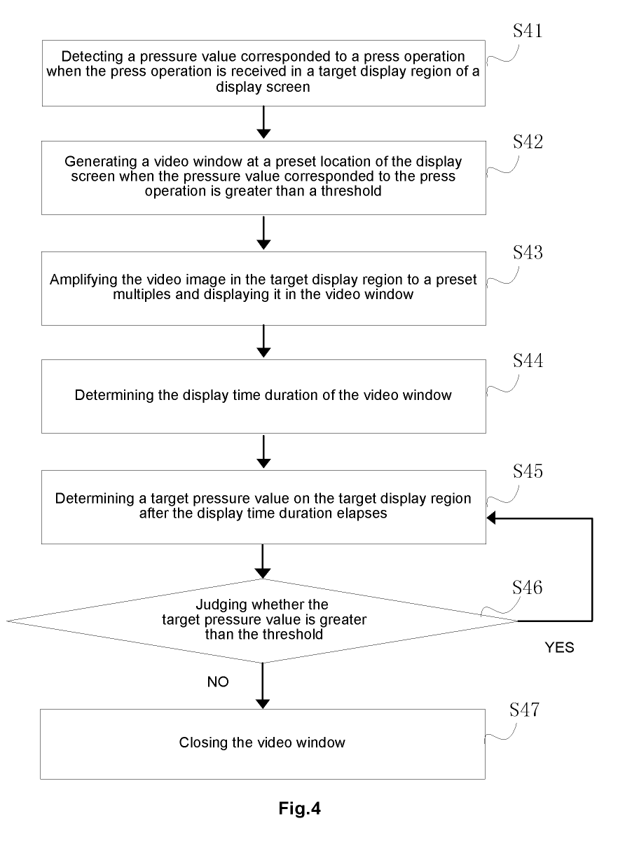

FIG. 4 is a flow chart of yet another method for amplifying a video image according to one embodiment of the disclosure. FIG. 4 is an optional embodiment based on FIG. 1, and in the embodiment shown in FIG. 4, for the part the same as that of the embodiment shown in FIG. 1, reference may be made to the introduction and explanation in the embodiment shown in FIG. 1. The method shown in FIG. 4 includes the steps of:

In Step S41: detecting a pressure value corresponded to a press operation when the press operation is received in a target display region of a display screen;

In Step S42: generating a video window at a preset location of the display screen when the pressure value corresponded to the press operation is greater than a threshold;

In Step S43: amplifying the video image in the target display region to a preset multiples and displaying it in the video window;

In Step S44: determining a display time duration of the video window.

Wherein, the display time duration of the video window refers to the time duration in which the video window is present on the display screen. For example, assuming that the display time duration of the video window is set as 1 minute in advance, then the mobile terminal will start timing when the video window gets generated; when the time duration in which the video window is present on the display screen is 1 minute, the mobile terminal will close the video window.

In Step S45: determining a target pressure value on the target display region when the display time duration elapses.

Wherein, after determining the display time duration of the video window, the mobile terminal needs to wait for the display time duration, and then again determines the target pressure value on the target display region, so as to determine whether the user expects to continue displaying the video window on the display screen.

In Step S46: judging whether the target pressure value is greater than the threshold, and triggering Step S45 when the target pressure value is greater than the threshold, or triggering Step S47 when the target pressure value is less than or equal to the threshold.

Wherein, after determining the target pressure value on the target display region, the mobile terminal further needs to determine whether the target pressure value is greater than the threshold. When the target pressure value is greater than the threshold, it means that the user presses target display region once more, which indicates that the user expects to continue watching the video window, thus the mobile terminal will not close the video window; and the mobile terminal will perform Step S45. When the target pressure value is less than or equal to the threshold, it means that the user does not expect to continue watching the video window, thus the mobile terminal will close the video window.

In Step S47: closing the video window.

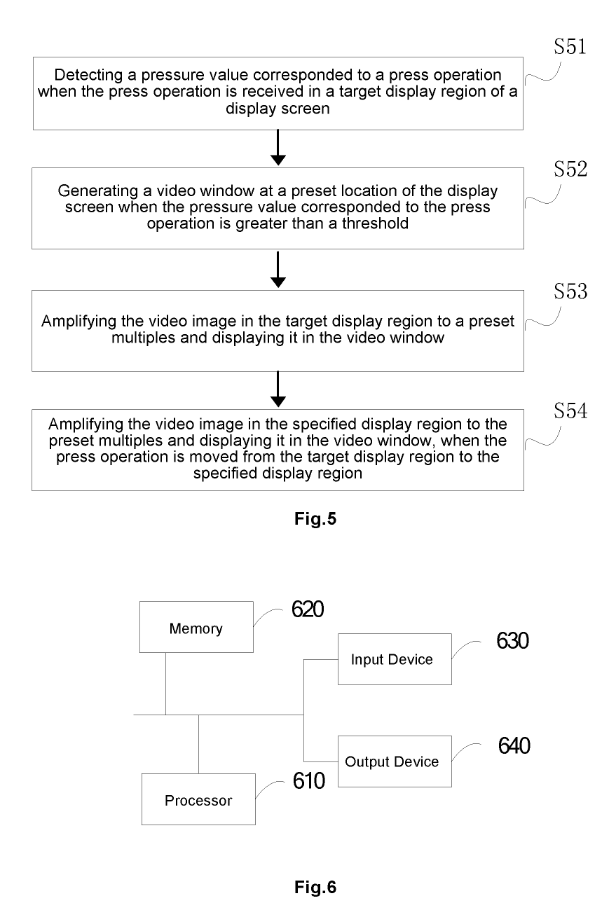

FIG. 5 is a flow chart of yet another method for amplifying a video image according to one embodiment of the disclosure. FIG. 5 is an optional embodiment based on FIG. 1, and in the embodiment shown in FIG. 5, for the part the same as that of the embodiment shown in FIG. 1, reference may be made to the introduction and explanation in the embodiment shown in FIG. 1. The method shown in FIG. 5 includes the steps of:

In Step S51: detecting a pressure value corresponded to a press operation when the press operation is received in a target display region of a display screen;

In Step S52: generating a video window at a preset location of the display screen when the pressure value corresponded to the press operation is greater than a threshold;

In Step S53: amplifying the video image in the target display region to a preset multiples and displaying it in the video window;

In Step S54: amplifying the video image in a specified display region to the preset multiples and displaying it in the video window, when the press operation is moved from the target display region to the specified display region.

Wherein, after the mobile terminal amplifies the video image in the target display region to a preset multiples and displays it in the video window, the mobile terminal will determine whether the press operation is moved from the target display region to the specified display region. When the mobile terminal determines that the press operation is moved from the target display region to the specified display region, which means that the user wants to watch the video image in the specified display region carefully at this point, then the mobile terminal will amplify the video image in the specified display region to the preset multiples and display it in the video window.

Additionally, the mobile terminal may determine whether the press operation is moved from the target display region to the specified display region according to the pressure value of the press operation. If the mobile terminal determines that the pressure value in the target display region is less than the threshold but the pressure value in the specified display region is greater than the threshold, it means that the press operation is moved from the target display region to the specified display region.

An embodiment of the disclosure provides a device for amplifying a video image. The device includes a detection module 11, a generation module 12 and a first display module 13, wherein:

the detection module 11 is configured for detecting a pressure value corresponded to a press operation when the press operation is received in a target display region of a display screen;

the generation module 12 is configured for generating a video window at a preset location of the display screen when the pressure value corresponded to the press operation is greater than a threshold; and

the first display module 13 is configured for amplifying the video image in the target display region to a preset multiples and displaying it in the video window.

An embodiment of the disclosure provides another device for amplifying a video image. The device includes a detection module 21, a generation module 22, a first display module 23, a recognition module 24 and a second display module 25, wherein:

the detection module 21 is configured for detecting a pressure value corresponded to a press operation when the press operation is received in a target display region of a display screen;

the generation module 22 is configured for generating a video window at a preset location of the display screen when the pressure value corresponded to the press operation is greater than a threshold;

the first display module 23 is configured for amplifying the video image in the target display region to a preset multiples and displaying it in the video window;

the recognition module 24 is configured for recognizing a human face image in the target display region via an image recognition technology; and

the second display module 25 is configured for amplifying the video image in a specified display region to the preset multiples and then displaying it in the video window when the human face image is moved from the target display region to the specified display region.

An embodiment of the disclosure provides yet another device for amplifying a video image. The device includes a detection module 31, a generation module 32, a first display module 33, a first determination module 34 and a first close module 35, wherein:

the detection module 31 is configured for detecting a pressure value corresponded to a press operation when the press operation is received in a target display region of a display screen;

the generation module 32 is configured for generating a video window at a preset location of the display screen when the pressure value corresponded to the press operation is greater than a threshold;

the first display module 33 is configured for amplifying the video image in the target display region to a preset multiples and displaying it in the video window;

the first determination module 34 is configured for determining a display time duration of the video window and an initial time for generating the video window; and

the first close module 35 is configured for closing the video window when the difference between the current time and the initial time is equal to the display time duration.

An embodiment of the disclosure provides yet another device for amplifying a video image. The device includes a detection module 41, a generation module 42, a first display module 43, a second determination module 44, a third determination module 45, a judgement module 46, a trigger module 47 and a second close module 48, wherein:

the detection module 41 is configured for detecting a pressure value corresponded to a press operation when the press operation is received in a target display region of a display screen;

the generation module 42 is configured for generating a video window at a preset location of the display screen when the pressure value corresponded to the press operation is greater than a threshold;

the first display module 43 is configured for amplifying the video image in the target display region to a preset multiples and displaying it in the video window;

the second determination module 44 is configured for determining a display time duration of the video window;

the third determination module 45 is configured for determining a target pressure value on the target display region when the display time duration elapses;

the judgement module 46 is configured for judging whether the target pressure value is greater than the threshold;

the trigger module 47 is configured for triggering the third determination module 45 when the target pressure value is greater than the threshold; and

the second close module 48 is configured for closing the video window when the target pressure value is less than or equal to the threshold.

An embodiment of the disclosure provides yet another device for amplifying a video image. The device includes a detection module 51, a generation module 52, a first display module 53 and a third display module 54, wherein:

the detection module 51 is configured for detecting a pressure value corresponded to a press operation when the press operation is received in a target display region of a display screen;

the generation module 52 is configured for generating a video window at a preset location of the display screen when the pressure value corresponded to the press operation is greater than a threshold;

the first display module 53 is configured for amplifying the video image in the target display region to a preset multiples and displaying it in the video window; and

the third display module 54 is configured for amplifying the video image in a specified display region to the preset multiples and displaying it in the video window when the press operation is moved from the target display region to the specified display region.

For the devices in the above embodiments, the specific mode in which each module thereof executes an operation has been described in detail in the embodiments of the related method, and it will not be again illustrated in detail here.

The present disclosure provides a non-transitory computer-readable storage medium storing executable instructions that, when executed by an electronic device with a touch-sensitive display, cause the electronic device to execute any one of the above methods for amplifying a video image according to the embodiments of present disclosure.

FIG. 6 is a diagram illustrating a hardware structure of an electronic device which can execute the method for amplifying a video image provided by an embodiment of the disclosure. As shown in FIG. 6, the electronic device includes:

at least one processor 610 and a memory 620, wherein only one processor 610 is illustratively shown in FIG. 6.

The device executing the method for amplifying a video image may also include: an input device 630 and an output device 640.

The processor 610, memory 620, input device 630 and output device 640 may be connected via a bus or other means, wherein a connecting bus is illustratively shown in FIG. 6.

The memory 620, as a non-volatile computer readable storage medium, may be used to store non-volatile software programs, non-volatile computer executable programs and modules, such as the program commands/modules corresponded to the method for amplifying a video image according to the embodiments in the present disclosure. The processor 610, by running non-volatile software programs, commands and modules stored in the memory 620, performs various functional applications and data processing of the server, i.e., carries out the method for amplifying a video image according to the above embodiments in the present disclosure.

The memory 620 may include a program storage area and a data storage area, wherein the program storage area may be used to store application programs needed by an operating system or by at least one function, and the data storage area may be used to store data created by running the device for amplifying a video image, and the like. Moreover, the memory 620 may include a high speed random access memory, and also may include a non-volatile memory, such as at least one disk memory, flash memory, or other non-volatile solid state memory. According to some embodiments, the memory 620 may optionally include memories that are remotely setup with respect to the processor 610, and these remote memories may be connected to the device for amplifying a video image via a network connection. An example of such a network includes, but not limited to, internet, intranet, local area network, mobile communication network, and a combination thereof.

The input device 630 may receive input digital or character information, and generate key signal inputs concerned with user setting and functional control of the device for amplifying a video image. The output device 640 may include displaying means such as a display screen.

The at least one module is stored in the memory 620, and, when run by the at least one processor 610, executes the method for amplifying a video image according to any one of the above method embodiments.

The above product may excite the method provided by the embodiments of the present disclosure, and has functional modules and beneficial effects corresponded to the executed method. As for technical details that are not elaborated in the present embodiments, reference can be made to the method provided by the embodiments of the present disclosure.

The electronic devices in the embodiments of the present disclosure exists in various forms, including but not limited to:

(1) mobile communication devices, characterized in having a function of mobile communication mainly aimed at providing speech and data communication, wherein such terminal includes: smart phone (such as iPhone), multimedia phone, functional phone, low end phone and the like.;

(2) ultra mobile personal computer devices, which falls in a scope of personal computer, has functions of calculation and processing, and generally has characteristics of mobile internet access, wherein such terminal includes: PDA, MID and UMPC devices, such as iPad;

(3) portable entertainment devices, which can display and play multimedia contents, anc includes audio or video player (such as iPod), portable game console, E-book and intelligent toys and portable vehicle navigation devices;

(4) server, a device for providing computing service, constituted by processor, hard disc, internal memory, system bus, and the like, which has a framework similar to that of a computer, but is demanded for superior processing ability, stability, reliability, security, extendibility and manageability due to that high reliable services are desired; and

(5) other electronic devices having a function of data interaction.

The above mentioned examples for the apparatus are merely exemplary, wherein the unit illustrated as a separated component may be or may not be physically separated, the component illustrated as a unit may be or may not be a physical unit, in other words, may be either disposed in some place or distributed to a plurality of network units. All or part of modules may be selected as actually required to realize the objects of the present disclosure. Such selection may be understood and implemented by ordinary skill in the art without creative work.

According to the description in connection with the above embodiments, it can be clearly understood by ordinary skill in the art that various embodiments can be realized by means of software in combination with necessary universal hardware platform, and certainly, may further be realized by means of hardware. Based on such understanding, the above technical solutions in substance or the part thereof that makes a contribution to the prior art may be embodied in a form of a software product which can be stored in a computer-readable storage medium, such as ROM/RAM, magnetic disk and compact disc, and includes several instructions for allowing a computer apparatus (which may be a personal computer, a server, a network device or the like) to execute the methods described in various embodiments or some parts thereof.

Finally, it should be stated that, the above embodiments are merely used for illustrating the technical solutions of the present disclosure, rather than limiting them. Although the present disclosure has been illustrated in details in reference to the above embodiments, it should be understood by ordinary skill in the art that some modifications can be made to the technical solutions of the above embodiments, or part of technical features can be substituted with equivalents thereof. Such modifications and substitutions do not cause the corresponding technical features to depart in substance from the spirit and scope of the technical solutions of various embodiments of the present disclosure.

What is claimed is:

1. A method for amplifying a video image applied to an electronic device, comprising:
detecting a pressure value corresponded to a press operation when the press operation is received in a target display region of a display screen;
generating a video window on a preset location of the display screen when the pressure value corresponded to the press operation is greater than a threshold; and
amplifying the video image in the target display region to a preset multiples and displaying it in the video window.

2. The method for amplifying a video image according to claim 1 or the invention of any claim herein, wherein after amplifying the video image in the target display region to a preset multiples and displaying it in the video window, the method further comprises:
recognizing a human face image in the target display region via an image recognition technology; and
amplifying the video image in a specified display region to the preset multiples and displaying it in the video window when the human face image is moved from the target display region to the specified display region.

3. The method for amplifying a video image according to claim 1 or the invention of any claim herein, wherein after amplifying the video image in the target display region to a preset multiples and displaying it in the video window, the method further comprises:
determining a display time duration of the video window and an initial time for generating the video window; and
closing the video window when the difference between the current time and the initial time is equal to the display time duration.

4. The method for amplifying a video image according to claim 1 or the invention of any claim herein, wherein after amplifying the video image in the target display region to a preset multiples and displaying it in the video window, the method further comprises:
determining a display time duration of the video window;
determining a target pressure value on the target display region after the display time duration elapses;
judging whether the target pressure value is greater than the threshold;
triggering the step of determining the target pressure value on the target display region after the display time duration elapses when the target pressure value is greater than the threshold; and
closing the video window when the target pressure value is less than or equal to the threshold.

5. The method for amplifying a video image according to claim 1 or the invention of any claim herein, wherein after amplifying the video image in the target display region to a preset multiples and displaying it in the video window, the method further comprises:
amplifying the video image in a specified display region to the preset multiples and displaying it in the video window when the press operation is moved from the target display region to the specified display region.

6. A non-transitory computer-readable storage medium storing executable instructions that, when executed by an electronic device with a touch-sensitive display, cause the electronic device to:
detect a pressure value corresponded to a press operation when the press operation is received in a target display region of a display screen;
generate a video window on a preset location of the display screen when the pressure value corresponded to the press operation is greater than a threshold; and
amplify the video image in the target display region to a preset multiples and displaying it in the video window.

7. The non-transitory computer-readable storage medium according to claim 6 or the invention of any claim herein, wherein after amplifying the video image in the target display region to a preset multiples and displaying it in the video window, the electronic device is further caused to:
recognize a human face image in the target display region via an image recognition technology; and
amplify the video image in a specified display region to the preset multiples and displaying it in the video window when the human face image is moved from the target display region to the specified display region.

8. The non-transitory computer-readable storage medium according to claim 6 or the invention of any claim herein, wherein after amplifying the video image in the target display region to a preset multiples and displaying it in the video window, the electronic device is further caused to:
determine a display time duration of the video window and an initial time for generating the video window; and
close the video window when the difference between the current time and the initial time is equal to the display time duration.

9. The non-transitory computer-readable storage medium according to claim 6 or the invention of any claim herein, wherein after amplifying the video image in the target display region to a preset multiples and displaying it in the video window, the electronic device is further caused to:
determe a display time duration of the video window;
determine a target pressure value on the target display region after the display time duration elapses;
judge whether the target pressure value is greater than the threshold;
trigger the third determination module when the target pressure value is greater than the threshold; and
close the video window when the target pressure value is less than or equal to the threshold.

10. The non-transitory computer-readable storage medium according to claim 6 or the invention of any claim herein, wherein after amplifying the video image in the target display region to a preset multiples and displaying it in the video window, the electronic device is further caused to:
amplify the video image in a specified display region to the preset multiples and display it in the video window when the press operation is moved from the target display region to the specified display region.

11. An electronic device, comprising: at least one processor; and
a memory communicably connected with the at least one processor for storing instructions executable by the at least one processor, wherein execution of the instructions by the at least one processor causes the at least one processor to:
detect pressure value corresponded to a press operation when the press operation is received in a target display region of a display screen;
generate a video window on a preset location of the display screen when the pressure value corresponded to the press operation is greater than a threshold; and
amplify the video image in the target display region to a preset multiples and displaying it in the video window.

12. The electronic device according to claim 11 or the invention of any claim herein, wherein after amplifying the video image in the target display region to a preset multiples and displaying it in the video window, the at least one processor is further caused to:
recognize a human face image in the target display region via an image recognition technology; and
amplify the video image in a specified display region to the preset multiples and displaying it in the video window when the human face image is moved from the target display region to the specified display region.

13. The electronic device according to claim 11 or the invention of any claim herein, wherein after amplifying the video image in the target display region to a preset multiples and displaying it in the video window, the at least one processor is further caused to:
determine a display time duration of the video window and an initial time for generating the video window; and
close the video window when the difference between the current time and the initial time is equal to the display time duration.

14. The electronic device according to claim 11 or the invention of any claim herein, wherein after amplifying the video image in the target display region to a preset multiples and displaying it in the video window, the at least one processor is further caused to:
determine a display time duration of the video window;
determine a target pressure value on the target display region after the display time duration elapses;
judge whether the target pressure value is greater than the threshold;
trigger the third determination module when the target pressure value is greater than the threshold; and
close the video window when the target pressure value is less than or equal to the threshold.

15. The electronic device according to claim 11 or the invention of any claim herein, wherein after amplifying the video image in the target display region to a preset multiples and displaying it in the video window, the at least one processor is further caused to:
amplify the video image in a specified display region to the preset multiples and displaying it in the video window when the press operation is moved from the target display region to the specified display region.
